(19) United States
(12) Patent Application Publication
(10) Pub. No.: US 2007/0165372 A1
(43) Pub. Date: Jul. 19, 2007

(54) Notebook computer with built-in web cam module

(76) Inventor: Chao-Qin Ye, Taipei County (TW)

Correspondence Address: Raymond Sun, 12420 Woodhall Way, Tustin, CA, 92782, US

(21) Appl. No.: 11/332,242

(22) Filed: Jan. 13, 2006

(51) Int. Cl. G06F 1/16

(52) U.S. Cl. 361/683

(57) ABSTRACT

A notebook computer has a notebook computer housing and a web cam module secured to the notebook computer housing. The web cam module has a web cam housing, with a lens and a motor retained inside the web cam housing. The motor has a driving shaft coupled to the lens for rotating the lens to an angled position, and the motor is powered and controlled by the notebook computer to adjust the angle of the lens.

### BACKGROUND OF THE INVENTION

1. Field of the Invention

The present invention relates to a web cam device, and in particular, to a web cam module which is built-in to a notebook computer.

2. Description of the Prior Art

Most web cam devices are connected to a desk top computer or notebook computer via an extra cable such that a user may locate the web cam device at any desired position or viewing angle. Examples of such wired web cam devices are illustrated in U.S. Pat. Nos. 6,663,066 and 6,845,954.

Some web cam devices are built into notebook computers. U.S. Pat. No. 5,880,928 illustrates a retractable web cam device which is hidden within the upper cover (or monitor) of a notebook computer. However, the viewing angle of this web cam device is permanently fixed unless the user further adjusts the opening angle of the monitor relative to the base. If the user does rotate the monitor, the content or image displayed on the monitor will be difficult to read.

In order to overcome the drawbacks mentioned above, U.S. Design Pat. No. D442,172 discloses an adjustable web cam device having a turnable knob that is coupled to the lens of the cam. However, the user needs to manually turn the knob to adjust the viewing angle.

### SUMMARY OF THE DISCLOSURE

It is an object of the present invention to provide a built-in web cam module which can be easily and conveniently operated by a notebook computer.

In order to accomplish the objects of the present invention, there is provided a notebook computer having a notebook computer housing and a web cam module secured to the notebook computer housing. The web cam module has a web cam housing, with a lens and a motor retained inside the web cam housing. The motor has a driving shaft coupled to the lens for rotating the lens to an angled position, and the motor is powered and controlled by the notebook computer to adjust the angle of the lens.

### BRIEF DESCRIPTION OF THE DRAWINGS

FIG. 1 is a perspective view of a notebook computer incorporating a web cam module according to the present invention.

FIG. 2 is an exploded perspective view of the web cam module according to the present invention.

FIG. 3 is top sectional view of the web cam module of FIG. 2.

FIG. 4 is a cross-sectional view of the web cam module of FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

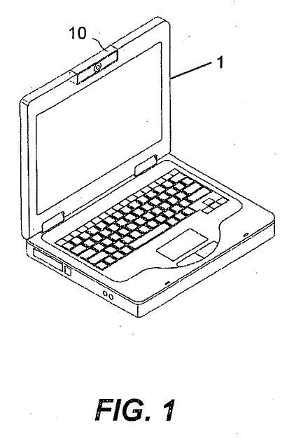

FIG. 1 illustrates a notebook computer that has a housing 1, with a portion of the housing 1 being adapted to accommodate a built-in web cam module 10. The web-cam module 10 can be fixedly secured to any part of the housing 1 of the notebook computer, and in FIG. 1, the web cam housing 13 of the web cam module 10 is fixedly secured to the cover or top housing of the notebook computer. The web cam housing 13 can also be integrated with the housing 1 such that the web cam housing 13 is part of the housing 1.

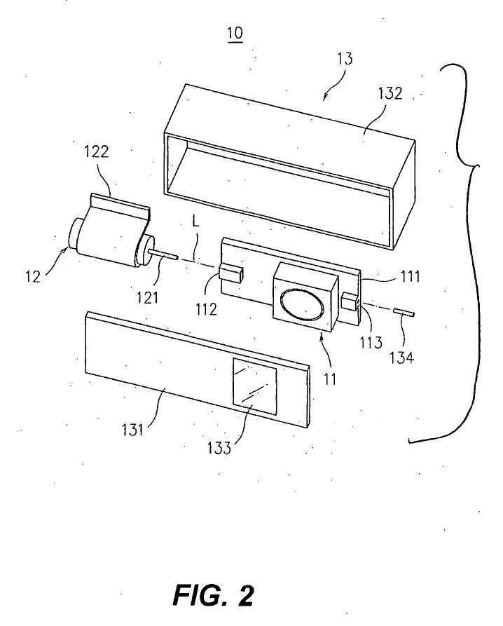

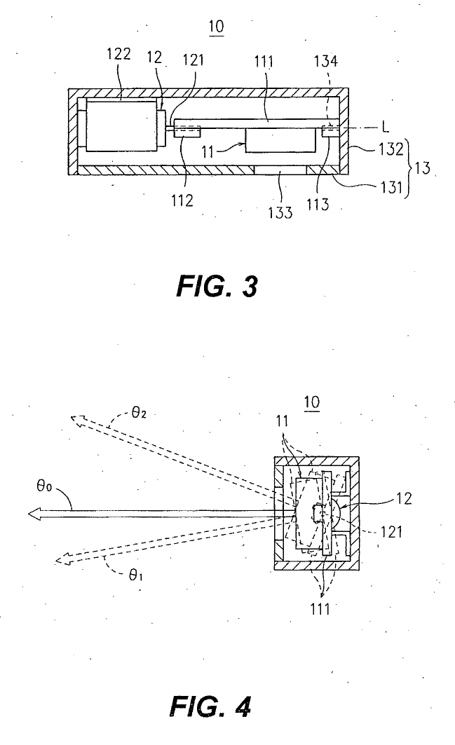

FIGS. 2-4 illustrate the web cam module 10, which has the web cam housing 13 that is made up of a cover 131 and a body 132. A lens 11 and a motor 12 are housed in the web cam housing 13. The motor 12 has a driving shaft 121 coupled to a first end 112 of the lens 11 for rotating the lens 11 to an angled position. The motor 12 can be powered and controlled by the notebook computer using techniques that are well-known in the art. The cover 131 further includes a transparent portion 133 which is positioned in front of the lens 11 so as to protect the lens 11 therein yet allow light to pass therethrough to the lens 11.

The motor 12 is positioned inside the web cam housing 13 by a fixing element 122. The fixing element 122 holds the motor 12, and is itself secured to the body 132. The driving shaft 121 is firmly coupled to the first end 112 for rotating the lens 11 to either an upper position or a lower position. A second end 113 of the lens 11 has an axle 134 which is rotatably coupled to the body 132. The driving shaft 121 and the axle 134 are located along the same axle line L (which defines the rotation axis for the lens 11) such that the motor 12 can rotate the lens 11 to a desired angled position.

The motor 12 can be a stepping motor, and the transparent portion 133 may be made of glass, acrylic plastic or the like. The cover 131 and the body 13 can be coupled together via any known mechanism, such as but not limited to welding, glue, snap-fit, etc.

Referring now to FIG. 4, the lens 11 is rotated by the driving shaft 121 inside the web cam housing 13. The motor 12 is in turn controlled by the processor (not shown) in the notebook computer, which executes a software that functions to control the adjustment of the lens 11. Therefore, the user may operate the notebook computer to rotate the lens 11 to either an upper position (θ2) or a lower position (θ1) from a neutral position (θ0) while eliminating the need to manually adjust the angle of the lens 11 of the web cam module 10.

In one embodiment of the present invention, the notebook computer can be provided with an automatic tracing program which allows the motor 12 to automatically trace the user's position for a preferred viewing angle. Such automatic tracing programs are well-known in the art, and can be embodied in the form of an image comparison program. A conventional image comparison program can operate in the following manner. First, the user saves his image (as captured by the lens 11). This saved image is then compared on a periodic basis by the processor with a newly-captured image from the lens 11. The difference between the saved image and the newly-captured image is then processed by the processor, which then issues a command signal to the motor 12 to rotate the shaft 121 accordingly to adjust the angle of the lens 11 to the optimum viewing angle. Thus, when the user moves forward or backward in his or her seat, the automatic tracing program can control the lens 11 to be rotated to an upper position (θ2) or a lower position (θ1) to provide the user with an optimum viewing angle position.

According to another embodiment of the present invention, the notebook computer can include appropriate software which allows the user to adjust the angle of the lens by inputting instructions via a keyboard or a mouse.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A notebook computer comprising:
a notebook computer housing;
a web cam module secured to the notebook computer housing, the web cam module having a web cam housing, with a lens and a motor retained inside the web cam housing, the motor having a driving shaft coupled to the lens for rotating the lens to an angled position; and
wherein the motor is powered and controlled by the notebook computer to adjust the angle of the lens.

2. The notebook computer of claim 1, wherein the lens is pivotally coupled to the web cam housing.

3. The notebook computer of claim 1, wherein the motor is a stepping motor.

4. The notebook computer of claim 1, wherein the web cam housing has a transparent portion in front of the lens.

5. The notebook computer of claim 1, wherein the web cam housing is integrated with the notebook computer housing.

6. A method of adjusting the angle of a lens in a web cam module that is fixedly secured to a notebook computer, comprising:
providing a web cam module having a web cam housing, with a lens and a motor retained inside the web cam housing, the motor having a driving shaft coupled to the lens;
providing the notebook computer with software for controlling the operation of the motor; and
providing command signals to the motor to cause the motor to rotate the lens to a desired angled position.

7. The method of claim 6, wherein the command signals are provided based upon commands input by the user via an input device.

8. The method of claim 6, wherein the command signals are provided based upon the user's current position with respect to the lens.
